(19) United States
(12) Patent Application Publication
(10) Pub. No.: US 2024/0328193 A1
(43) Pub. Date: Oct. 3, 2024

(54) ROSE AND HANDLE

(71) Applicant: Joseph Giles Limited, Crawley (GB)

(72) Inventors: Giles HARWOOD, Surrey (GB); Joseph HARWOOD, Surrey (GB); John HARWOOD, Surrey (GB)

(73) Assignee: Joseph Giles Limited, Crawley (GB)

(21) Appl. No.: 18/341,577

(22) Filed: Jun. 26, 2023

(30) Foreign Application Priority Data
Mar. 31, 2023 (GB) GB2304800.2

(51) Int. Cl. E05B 1/00

(52) U.S. Cl. CPC E05B 1/003

(57) ABSTRACT

There is a rose for a door handle, the rose comprising a body comprising a first face; a rotatable member configured to rotate about a first axis, the rotatable member comprising an outer perimeter; a spindle receiving aperture extending along the first axis, wherein the spindle receiving aperture extends through the body and the rotatable member; and a resilient member coiled about the first axis, the resilient member comprising a fixed end and a free end, wherein the fixed end is fixed to the body and the free end is coupled to the rotatable member; wherein the body comprises a recess defined by an inner perimeter, the recess configured to house the resilient member and the rotatable member; wherein the resilient member biases the rotatable member to a first position and in the first position the angle between the free end and the fixed end relative to the centre of the coiled resilient member is at least 90 degrees. There is further described a handle system for a door.

### FIELD OF THE INVENTION

The present invention relates to a rose for a door handle. The invention also relates to a handle system for a door comprising a rose.

### BACKGROUND TO THE INVENTION

A rose is a component of a door handle that couples a turning force provided by a user to a door handle to a door latch. A rose allows a sprung door latch mechanism to be provided, wherein the door handle mechanism is activated only when the handle is turned.

Due to their frequent use, the components of a door handle are prone to coming loose from one another, which may cause jamming of the latch mechanism or otherwise prevent smooth door opening. In many applications, such as in high-end markets or for doors subject to safety regulations, this is undesirable.

Further, it is not uncommon for large and/or heavy handles or knobs to be fitted to the door, making the rose of the door handle system prone to breaking or deforming with use. Additionally, in sprung door latch applications, the weight of the components of the door handle are liable to warp, deform or otherwise stress the spring over time, reducing the lifespan of the rose.

Objects and aspects of the present claimed invention seek to alleviate at least these problems with the prior art.

### SUMMARY OF THE INVENTION

According to a first aspect of the invention, there is provided a rose for a door handle, the rose comprising a body comprising a first face; a rotatable member configured to rotate about a first axis, the rotatable member comprising an outer perimeter; a spindle receiving aperture extending along the first axis, wherein the spindle receiving aperture extends through the body and the rotatable member; and a resilient member coiled about the first axis, the resilient member comprising a fixed end and a free end, wherein the fixed end is fixed to the body and the free end is coupled to the rotatable member; wherein the body comprises a recess defined by an inner perimeter, the recess configured to house the resilient member and the rotatable member; wherein the resilient member biases the rotatable member to a first position and in the first position the angle between the free end and the fixed end relative to the centre of the coiled resilient member is at least 90 degrees.

The rose is configured to receive a spindle within the spindle receiving aperture. In a door handle assembly, a spindle is coupled to and extends from the handle such that when the user turns the handle, the spindle also turns. The rose of the present invention biases the rotatable member, and consequently the handle of a door handle assembly, to a first position. The first position may be such that the door handle extends horizontal to the ground, in use.

In use, the rose may be coupled to a heavy or large doorknob or door handle, such as a horizontal solid metal door handle. The weight of the door handle under gravity can cause the door handle to sit at an angle to the horizontal, namely titled downwards. This may not be visually pleasing and may increase the difficulty of turning the door handle. As such, the resilient member opposes the force of the door handle under gravity and biases the rotatable member to the first position.

The configuration of the resilient member also causes smoother rotation of the rotatable member, therefore providing smooth turning of a door handle comprising the rose, as the rose is less susceptible to jamming. Therefore, there is provided a rose which allows for softer opening and return action of the handle.

Preferably, the rose is a door handle rose.

Preferably, in the first position the angle between the free end and the fixed end relative to the centre of the coiled resilient member is less than 180 degrees. More preferably, in the first position the angle between the free end and the fixed end relative to the centre of the coiled resilient member is less than 150 degrees.

Preferably, the rose comprises a front plate and the front plate is configured to wholly cover the portion of the first face of the body between the outer perimeter of the rotatable member and the inner perimeter of the recess such that the front plate occludes the recess. In this way, the opening of the recess housing the resilient member and the rotatable member is covered such that there is a lower risk of the rotatable member or resilient member being displaced during installation or use.

Alternatively, the rose comprises a front plate and the front plate is configured to wholly cover the first face of the body. In this way, there is a greater contact surface area between the front plate and the body. As such, the body and the front face can be more securely fixed together, better preventing of the rotatable member or resilient member being displaced during installation or use.

Preferably, the rose comprises a zinc aluminium alloy. Preferably, the rose comprises a polycarbonate. More preferably, the rose comprises a zinc aluminium alloy and a polycarbonate. It is understood that the zinc aluminium alloy has a base metal of zinc and alloying elements of aluminium. Preferably, the zinc aluminium alloy further comprises alloying elements of magnesium and/or copper. More preferably, the zinc aluminium alloy comprises 4% aluminium by total weight of the alloy. More preferably, the zinc aluminium alloy is Mazak.

Preferably, the polycarbonate is polycarbonate fulfilling the safety rating of UL94 V-0 at 2 mm thickness (the Standard for Safety of Flammability of Plastic Materials for Parts in Devices and Appliances testing), wherein burning stops within 10 seconds on a vertical specimen; drips of particles allowed as long as they are not inflamed. UL94 V-0 tests are generally conducted on a (127×12.7 mm) specimen of the minimum approved thickness.

The polycarbonate and zinc aluminium alloy materials provide a lighter rose than conventional materials, such as stainless steel. The weight improvement is advantageous during transportation and storage of the rose. Further, the lifespan of the rose may be increased as the overall weight of a door handle system incorporating the rose is reduced, lowering the likelihood of the resilient member warping, deforming or otherwise being put under stress during use.

Preferably, the resilient member is a spring. More preferably, the resilient member is a spring comprising at least 1.5 turns. In some embodiments, the resilient member is a spring comprising at least 2.5 turns. In this way, the spring is sturdier less likely to warp or twist during use. It is also preferable to minimise the number of coils to reduce footprint of the spring within the recess. In this way, a smaller recess is required to house the resilient member, providing a smaller rose and a more visually pleasing door handle system. Further, the resource demand of the rose is reduced.

Preferably, the spindle receiving aperture of the rotatable member is configured to have a transitional fit or interference fit with a spindle received in the spindle receiving aperture, wherein the rotatable member is rotatably coupled to a spindle received in the spindle receiving aperture. In this way, when a spindle is received within the spindle receiving aperture, rotation of the spindle is translated to rotation of the rotatable member. As the resilient member is coupled to the rotatable member, rotation of the spindle is opposed by the resilient member, providing a spring loaded door handle.

Preferably, the spindle receiving aperture of the body and the front plate is configured to have a clearance fit with a spindle received in the spindle receiving aperture, wherein the body and the front plate are not coupled to a spindle received in the spindle receiving aperture. In this way, the body and the front plate are fixed relative to a spindle received in the spindle receiving aperture, such that they remain stationary when the spindle is rotated.

Preferably, the rotatable member and the body comprise a first blocking member configured to inhibit rotation of the rotatable member beyond the first position. In this way, the rotatable member cannot be rotated past the first position, preventing over-compression of the resilient member.

Preferably, the rotatable member and the body comprise a second blocking member configured to inhibit rotation of the rotatable member beyond a second position. In this way, the rotatable member cannot be rotated past the second position, preventing over-extension of the resilient member.

Preferably, in the second positon the rotatable member is rotated less than 90 degrees From the first position. More preferably, in the second positon the rotatable member is rotated between 20 degrees to 60 degrees From the first position. Still more preferably, in the second positon the rotatable member is rotated 45° From the first position.

Preferably, the rotatable member comprises a third position, the third position being between the first position and the second position. Preferably, in the third position the angle between the free end and the fixed end relative to the centre of the coiled resilient member is between 20 degrees to 70 degrees From the first position. More preferably, in the third positon the rotatable member is rotated between 30 degrees to 60 degrees From the first position. In this way, the rose conforms with European standards and certifications. Such a feature is beneficial over prior known roses as the user is required to turn the door handle further before the latch of the door unlatches and the door can be opened.

Preferably, the rose comprises a visual indicator configured to indicate the configuration of the resilient member. In this way, the user can easily determine whether the rotatable member is configured to rotate in a clockwise or anticlockwise direction without disassembling the rose, such as by removing of the front plate to view the resilient member. Therefore, the risk of the user erroneously fitting the opposing configuration rose to a door handle assembly is reduced. In some embodiments, the visual indicator comprises one or more of the following; a protrusion, an aperture, lettering, a colour, an engraving or a symbol, such as an arrow. Preferably, the visual indicator comprises one or more letters located on the body or rotatable member.

Preferably, the rotatable member is configured to be housed between the inner perimeter of the recess and the resilient member. In this way, the resilient member is located within the rotatable member. Preferably, the free end of the resilient member is fixed to an inner perimeter of the rotatable member.

Preferably, the rose comprises at least one screw receiving aperture configured to receive a screw. In this way, the rose can be affixed to a door via screws. More preferably, the body and the front plate comprise the at least one screw receiving aperture. Preferably, the at least one screw receiving aperture in the body is located on a perimeter of the first face. In this way, complementary apertures for receiving screws allow screws to pass through both the front plate and the body. Preferably, the rose comprises at least two screw receiving apertures. More preferably, the rose comprises at least four screw receiving apertures. A compromise between the integrity of the rose and the number of screws must be made, considering the weight of the overall door handle assembly. It is understood that four screw receiving apertures will typically be sufficient to securely fix the rose to a door via screws. Alternatively, the rose comprises any suitable fixing means configured to fix the rose to a door, such as an adhesive.

Preferably, the first face of the body has a snowflake or star shaped cross-section. More preferably, the first face of the body has a star-shaped cross-section. Namely, the first face is annular with a plurality of equidistant protrusions. Preferably, a plurality of rivet apertures are located within the plurality of equidistant protrusions. Preferably, the first face of the body comprises a plurality of semi-circular apertures configured to house a portion of the front plate. Preferably, the front plate has an annulus shaped cross-section.

Preferably, the front plate is configured to interlock with the body. Preferably, the front plate comprises a plurality of interlock protrusions extending in a direction parallel to the first axis. Preferably, the plurality of semi-circular apertures of the body are configured to house the plurality of interlock protrusions of the front plate.

Preferably, the body and the front plate comprise a plurality of rivet apertures configured to receive a rivet. More, preferably, the body and the front plate each comprise eight rivet apertures. Preferably, the plurality of rivet apertures are equally spaced about the first axis. Such a configuration permits control of the rotational forces in the operation of the handle in the eight positions of the rivets and in sixteen additional positions spreading the rotational load.

Preferably, the rose comprises a plurality of rivets configured to interlock the front plate to the body. Preferably, the plurality of rivets are brass rivets. As such, when the body and the front plate are interlocked together, the plurality of rivets are configured to be received in the plurality of rivet apertures which are aligned between the body and the front plate.

Preferably, the rotatable member comprises a bearing configured to aid rotation of the rotatable member.

According to a second aspect of the invention, there is provided a handle system for a door, the handle system comprising the rose of any one preceding claim. Preferably, the handle system is a door handle system.

Preferably, the handle system comprises a latch assembly comprising a bolt or latch. Preferably, the handle system further comprises a spindle configured to be received in the spindle receiving aperture of the rose. Preferably, the spindle is coupled to the latch assembly such that rotational motion of the spindle is transferred to linear motion of the latch into and out of the latch assembly. Other types of latches are envisaged in the door handle system.

Preferably, the handle system further comprises at least one doorknob or handle coupled to the spindle, the doorknob or handle configured to aid user rotation of the spindle. It is understood that the doorknob may be any conventional knob, handle or other appropriate turning means which the user grips and turns to unlatch the door. Preferably, the handle system comprises a pair of opposing doorknobs. A doorknob of the pair of doorknobs may be located on either side of the door, in use.

Preferably, the handle system further comprises a cover configured to cover the rose. In this way, the rose is better protected from the external environment and a more visually pleasing handle system is provided.

### DETAILED DESCRIPTION

Embodiments of the present invention will now be described by way of example only and with reference to the accompanying drawings, in which:

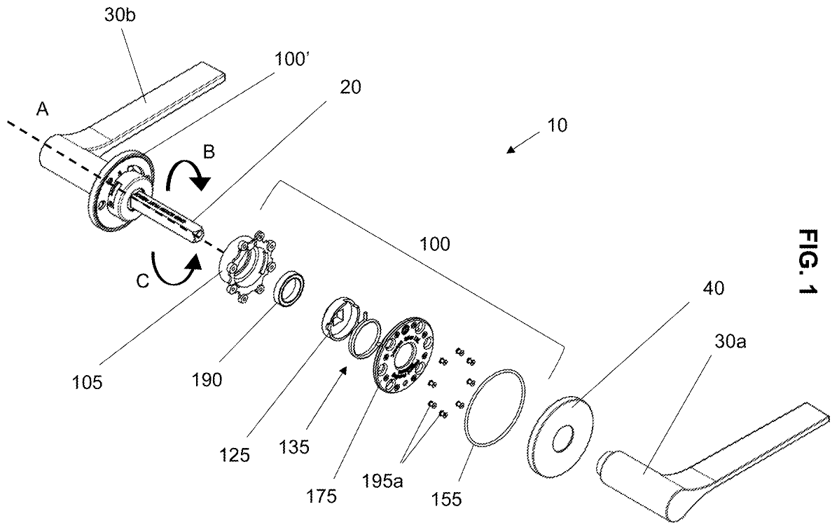

FIG. 1 depicts a deconstructed view of a handle system in accordance with the second aspect of the invention, the handle system comprising a rose in accordance with the first aspect of the invention;

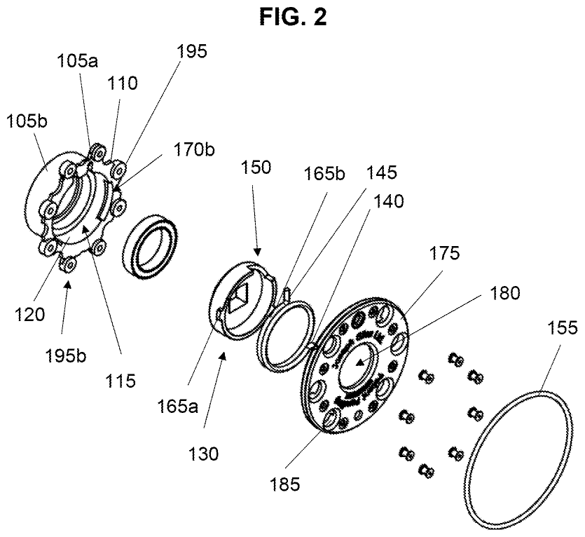

FIG. 2 depicts a deconstructed view of the rose of FIG. 1;

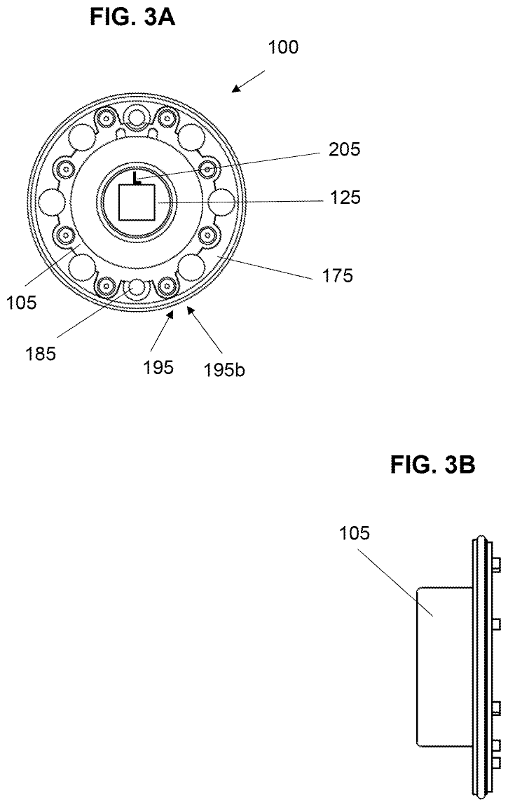

FIGS. 3A and 3B depict rear and side views, respectively, of the rose of FIG. 1;

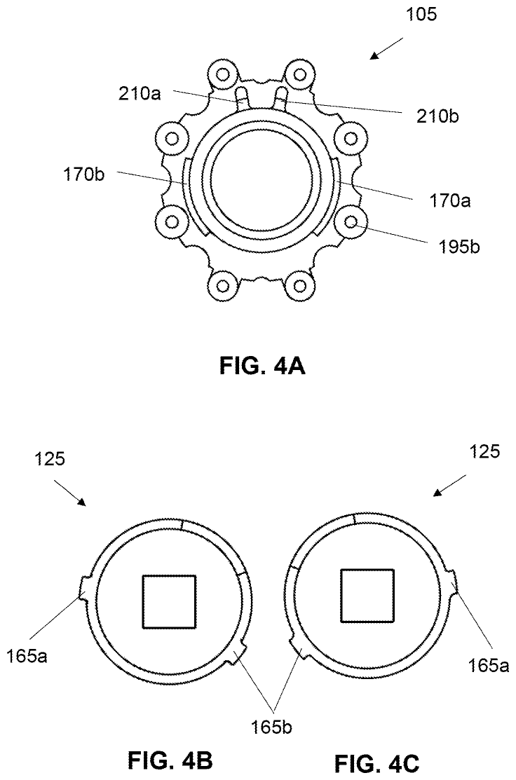

FIGS. 4A depicts a rear view of the assembly of the front plate, body and rotatable member of FIG. 1;

FIGS. 4B and 4C depict two opposite rotatable member configurations of the rose of FIG. 1; and

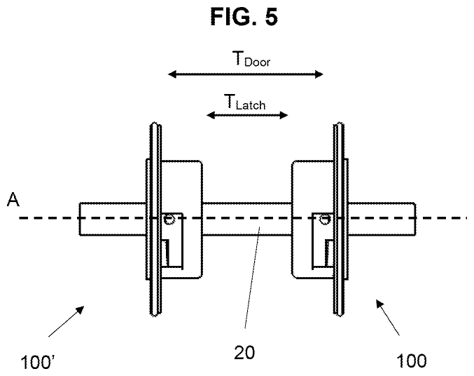

FIG. 5 depicts a side view of a portion of the handle system of FIG. 1.

With reference to FIG. 1, a door handle system 10 is illustrated. The door handle system 10 comprises a door handle rose 100, the handle system 10 configured to be mounted to a door (not pictured). The rose 100 is further illustrated in FIGS. 2A to 2C.

With reference to FIGS. 2 to 4C, the rose 100 comprises a body 105 comprising a first face 110, the first face 110 configured in use to face away from the door. The first face 110 is substantially star-shaped and is substantially flat. The first face 110 is located on a disc-shaped first portion 105a of the body. The body 105 further comprises a cylindrical second portion 105b connected centrally to the first portion 105a. The body 105 is integrally formed and is a single unit. The body 105 comprises a recess 115 defined by an inner perimeter 120, the recess extending from the first face 110 of the body 105 into the first portion 105a and second portion 105b. The recess 115 has a stepped profile such that the width of the recess decreases with distance from the first face 110.

The rose 100 further comprises a rotatable member 125 configured to rotate about a first axis A. The rotatable member 125 is configured to rotate both clockwise and anticlockwise about the first axis A.

The rose 100 further comprises a resilient member 135 comprising a coiled torsion spring. The spring 135 is made of metal. The spring 135 is coiled about the first axis A such that the first axis A intersects the centre of the coil. The spring 135 comprises a fixed end 140 and an opposing free end 145. It is understood that fixed and free are taken to mean that the fixed end 140 is not free to move relative to the body 105 and the free end 140 is permitted to move relative to the body 105. The free end 140 and fixed end 140 protrude perpendicularly from the coiled spring 135. The body 105 comprises a fixed end receiving aperture 210a, 210b configured to receive the protruding fixed end 140, such that the fixed end 140 is fixed to the body 105 via the fixed end receiving aperture. As illustrated in FIG. 4A, the body 105 can be manufactured to house a spring configured for left-hand turning of the handle, shown by fixed end receiving aperture 210a, and configured for right-hand turning of the handle, shown by fixed end receiving aperture 210b.

The recess 115 of the body 105 is configured to house the resilient member 135 and the rotatable member 125. The rotatable member 125 is configured to be housed within the recess 115 with a clearance fit such that the rotatable member 125 is free to rotate relative to the body 105. The rotatable member 125 comprises a first guide member 165a and a second guide member 165b protruding perpendicularly from the rotatable member 125, in a direction perpendicular to the first axis A. The first portion 105a of the body 105 comprises a first guide member receiving aperture 170a configured to receive the first guide member 165a and a second guide member receiving aperture 170b configured to receive the guide member 165b, thereby allowing the rotatable member 125 to be received in the recess 115 and to rotate relative to the body 105 when the rotatable member 125 is received within the recess. Rotational motion of the rotatable member 125 is blocked when the first guide member 165a abuts the distal ends of the first guide member receiving aperture and rotational motion of the rotatable member 125 is blocked when the second guide member 165b abuts the distal ends of the second guide member receiving aperture 170b. In this way, a blocking member is provided, the blocking member comprises the first and second guide members 165a, 165b and the first and second guide member receiving apertures 170a, 170b. In this way, the rotatable member 125 is prevented from over-rotating during use. The length and location of the first and second guide member receiving apertures 170a, 170b determines the angle of rotation that can be achieved by the rotatable member 125.

The first face 110 of the body 105 acts as a retention tab configured to retain the rotatable member 125 in the recess 115 by inhibiting removal of the rotatable member 125 from the recess 115.

The rotatable member 125 comprises a cavity 130 configured to house a resilient member 140. The cavity 130 has a circular cross section complimentary to the coiled spring 135 such that the coil spring 135 is received within the cavity 130 with a clearance fit. The cavity 130 is configured to be outwardly facing, namely facing away from the door, in use. In this way, the rotatable member 125 is located between the inner perimeter 120 of the recess 115 and the spring 135.

The rose 100 further comprises a bearing 190 configured to be housed within the recess 115. The bearing 190 is located between the second portion 105b of the body 105 and the rotatable member 125 and aids rotation of the rotatable member 125.

The rotatable member 125 further comprises a fixed end pathway 150 defined by an elongate aperture. The fixed end pathway 150 is configured to receive the fixed end 140 of the spring 135 and permits rotation of the rotatable member 125 before the protruding fixed end 140 abuts and blocks the rotatable member 125. The length and location of the fixed end pathway 150 again determines the angle of rotation that can be achieved by the rotatable member 125, and is complementary to the guide member receiving apertures 170a, 170b. The rotatable member 125 further comprises a free end receiving aperture configured to receive the free end 145 of the spring 135. The free end 145 is therefore fixed relative to the rotatable member 125, and rotational motion of the rotatable member 125 is translated directly to rotational motion of the free end 145. As the rotatable member 125 is free to rotate relative to the body 105, the free end 145 is therefore also free to rotate relative to the body 105.

The rose 100 further comprises an annular front plate 175 configured to wholly cover the first face 110 of the body 105. The front plate 175 is configured to interlock with the first face 110 via connection of the plurality of interlock protrusions of the first face 110 with the plurality of semi-circular apertures of the body 105. The front plate 175 further comprises a plurality of rivet apertures 195 configured to receive a plurality of rivets 195a. The body 105 also comprises a plurality of rivet apertures 195b configured to receive the plurality of rivets 195a. In this way, the front plate 175 and the body 105 interlock with one another such that the plurality of rivet apertures 195, 195b align when the front plate 175 is interlocked and retained the body 105.

The rose comprises a spindle receiving aperture 180 extending along the first axis A. The spindle receiving aperture 180 is located in the first portion 105a and second portion 105b of the body 105, the rotatable member 125 and the front plate 175, such that the spindle receiving aperture 180 extends the length of the rose 100. In this way, a spindle 20 of a handle system 10 can be received with the spindle receiving aperture 180. The spindle 20 is configured to protrude from either end of the spindle receiving aperture 180 such that a pair of handles 30a, 30b of a handle system 10 can be fixed to the ends of the spindle 20.

The spindle 20 has a square cross-section and the spindle receiving apertures 180 of the body 105 and the front plate 175 are circular, with the radius of the circle greater than the length of the cross-section sides of the spindle 20 so that the spindle 20 can freely rotate in the spindle receiving apertures 180. In this way, the spindle receiving aperture 180 of the body 105 and the front plate 175 is configured to have a clearance fit with the spindle 20 received in the spindle receiving aperture 180. The body 105 and the front plate 175 are not coupled to the spindle 20 and do not rotate when the spindle 20 is rotated. In this way, the rose 100 can be fixed to the door such that the body 105 and the front plate 175 are fixed relative to the door.

The spindle receiving aperture 180 of the rotatable member 125 is square in shape and is of substantially the same size as the cross-section of the spindle. Namely, the spindle receiving aperture 180 of the rotatable member 125 is square with sides that are each 8 mm in length. In this way, the spindle receiving aperture 180 of the rotatable member has a transitional fit with the spindle 20 received in the spindle receiving aperture 180. Therefore, the rotatable member 125 is coupled to the spindle 20 and rotational motion of the spindle 20 is directly translated into rotational motion of the rotatable member 125. The spindle 20 is configured to rotate about the first axis A when the spindle 20 is received in the spindle receiving aperture 180. The spindle 20 is configured to rotate in an unlatching direction B and an opposing latching direction C, and the rotatable member 125 is also configured to rotate in the unlatching direction B and opposing latching direction C.

It is understood that the latching direction C is the direction in which the spindle 20 rotates about the first axis A to cause a latched door to unlatch, and the latching direction C is the opposing direction in which the spindle 20 rotates about the first axis A to cause a latch of a latched door to become fastened.

When the spindle 20 is rotated in the unlatching direction B, such as by a user applying a turning force, the coiled spring 135 is configured to compress as a force is provided on the free end 145 of the rotatable member 125. Namely, a compressive force is applied to the free end 145 of the torsion spring 135 and subsequently the compressive force is transferred along the spring 135 in a direction towards the fixed end 140. When the turning force on the spindle 20 is removed, the spring 135 decompresses and returns to its uncompressed configuration and the free end 145 returns to its neutral position.

In this way, the spring 135 biases the rotatable member 125 to a first position. Namely, the first position is the position of the rotatable member 125 when the spring 135 is in the uncompressed, or neutral, configuration.

The blocking member comprising the first and second guide members 165a, 165b and the first and second guide member receiving apertures 170a, 170b is configured to inhibit rotation of the rotatable member 125 beyond a second position. In the second position, the rotatable member 125 is at a maximum rotation from the first position due to the blocking member.

The front plate 175, body 105 and rotatable member 125 are made from a combination of a zinc aluminium alloy (Mazak) and polycarbonate (UL94 V-0 at 2 mm thickness). In this way, a lightweight rose 100 is provided.

The first portion 105a of the body 105 comprises six screw receiving apertures 185 configured to receive a screw. The front plate 175 comprises six complementary screw receiving apertures 185, such that a screw can be received in each aperture when the front plate 175 is fixed to the body 105. In this way, the rose 100 can be screwed to a door. The screw receiving apertures 185 comprises a first pair of apertures spaced 38 mm apart from one another and a second pair of apertures spaced 38 mm apart from one another, the second pair of apertures smaller in diameter than the first pair of apertures.

In this way, the rose 100 is compatible with standard UK door latches.

In this embodiment, the first face 110 has a maximum diameter of 49 mm. The depth of the first portion 105a with the front plate 175 plastically welded to the fist face 110 is 4 mm. The depth of the second portion 105b is 10 mm.

The door handle system 10 further comprises a seal 155 configured to be located about the perimeter of the front plate 175 and between the front plate 175 and a cover 40.

A visual indicator 205 is located on the rotatable member 125. The visual indicator 205 of this embodiment comprises the letter ‘L’. The visual indicator may be marked, embossed or engraved to improve visibility.

FIGS. 4B and 4C depict clockwise and anti-clockwise (or left and right) configurations of the rotatable member 125. Both configurations can be manufactured from the same tooling.

Referring again to FIGS. 1 and 5, the door handle system 10 of the second aspect of the invention comprises the rose 100 of the first aspect of the invention, a spindle 20 and a pair of handles 30a, 30b. The door handle system 10 is configured to be mounted to a door. In this embodiment, the handle is an elongate handle rather than a doorknob, but it is understood that the type of handle is not particularly limited and a doorknob could be used. The handle 30a, 30b provides an object for the user to grip and rotate to open and close the door.

The door handle system 10 further comprises a latch assembly comprising a latch (not pictured). The latch assembly operates in the standard way, wherein the latch is coupled to the spindle 20 such that rotation of the spindle 20 in the unlatching direction B draws the latch, enabling the door to be opened, and rotation of the spindle 20 in the latching direction C returns the latch to the undrawn position.

The handle system 10 further comprises a cover 40 configured to cover the rose 100 from the external environment. In this way, the cover 40 protects the rose 100 and provides a more visually pleasing handle system 10. The rose 100 is located between the cover 40 and the door.

The first axis A defines a longitudinal axis of the handle system 10. The user can rotate either of the handles 30, 30b in the unlatching direction B. The handles 30a, 30b are coupled to the spindle 20 and therefore also coupled to the rotatable member 125 of the rose 100. Therefore, turning either handle 30, 30b in the unlatching direction B moves the rotatable member 125 from the first position towards the second position, compressing the spring 135. The latch of the latch assembly is also coupled to the spindle 20 and by rotating the handle 30a, 30b in the unlatching direction B, the latch is drawn and the door can be opened.

When the user releases the handle 30a, 30b or turns the handle 30a, 30b in the latching direction C, the compression force on the spring 135 is removed and the rotatable member 125 returns to the first position. In this way, the rose 100 biases the handle to a default or neutral position.

The handle system 10 further comprises a second rose 100′ identical to the first rose 100 but configured so that the rotatable member 125 can rotate in an opposing direction. In this way, the second rose 100′ has the same unlatching direction B and latching direction C as the rose 100, when looking along either direction of the first axis A. As such, either handle 301, 30b can be smoothly turned with both roses 100, 100′ providing complementary functions. A rose 100, 100′ is arranged on either side of the door, in use. In this way, each rose 100, 100′ abuts, and is fixed to, the door.

With reference to FIG. 5, the handle assembly 10 comprises a latch thickness T_{Latch} defined by the minimum distance between the pair of roses 100, 100′. The latch thickness T_{Latch} can be varied dependent on the type and size of latch assembly.

The handle assembly 10 further comprises a door thickness T_{Door} defined by the minimum distance between the first portion 105a of the body 105 of the pair of roses 100, 100′. The door thickness T_{Door} corresponds to the thickness of the door between the pair of roses 100, 100′. In this way, the second portion 105b of the body 105 of each rose 100, 100′ is configured to be received within an aperture in the door, such that the first portion 105a of the body 105 abuts an outer surface of the door. The minimum door thickness T_{Door} of this embodiment is 36 mm.

Further embodiments within the scope of the present invention may be envisaged that have not been described above. The invention is not limited to the specific examples or structures illustrated, a greater number of components than are illustrated in the figures could be used, for example.

1. A rose for a door handle, the rose comprising a body comprising a first face;
a rotatable member configured to rotate about a first axis, the rotatable member comprising an outer perimeter;
a spindle receiving aperture extending along the first axis, wherein the spindle receiving aperture extends through the body and the rotatable member; and
a resilient member coiled about the first axis, the resilient member comprising a fixed end and a free end, wherein the fixed end is fixed to the body and the free end is coupled to the rotatable member;
wherein the body comprises a recess defined by an inner perimeter, the recess configured to house the resilient member and the rotatable member;
wherein the resilient member biases the rotatable member to a first position and in the first position the angle between the free end and the fixed end relative to the centre of the coiled resilient member is at least 90 degrees.

2. The rose of claim 1, wherein the rose comprises a front plate and the front plate is configured to wholly cover the portion of the first face of the body between the outer perimeter of the rotatable member and the inner perimeter of the recess such that the front plate occludes the recess.

3. The rose of claim 1, wherein the rose comprises a front plate and the front plate is configured to wholly cover the first face of the body.

4. The rose of claim 2, wherein the front plate is configured to interlock with the body.

5. The rose of claim 1, wherein the rose comprises a zinc aluminium alloy and a polycarbonate.

6. The rose of claim 1, wherein the resilient member is a spring comprising at least 1.5 turns.

7. The rose of claim 1, wherein the spindle receiving aperture of the rotatable member is configured to have a transitional fit or interference fit with a spindle received in the spindle receiving aperture, wherein the rotatable member is rotatably coupled to a spindle received in the spindle receiving aperture.

8. The rose of claim 2, wherein the spindle receiving aperture of the body and the front plate is configured to have a clearance fit with a spindle received in the spindle receiving aperture, wherein the body and the front plate are not coupled to a spindle received in the spindle receiving aperture.

9. The rose of claim 1, wherein the rotatable member and the body comprise a blocking member configured to inhibit rotation of the rotatable member beyond a second position.

10. The rose of claim 9, wherein in the second positon the rotatable member is rotated 30° From the first position.

11. The rose of claim 1, wherein the rose comprises a visual indicator configured to indicate the configuration of the resilient member.

12. The rose of claim 11, wherein the visual indicator comprises one or more letters located on the body or rotatable member.

13. The rose of claim 1, wherein the rotatable member is configured to be housed between the inner perimeter of the recess and the resilient member.

14. The rose of claim 2, wherein the front plate has an annulus shaped cross-section.

15. The rose of claim 1, wherein the rotatable member comprises a bearing configured to aid rotation of the rotatable member.

16. The rose of claim 1, wherein the first face of the body has a star-shaped cross-section.

17. A handle system for a door, the handle system comprising the a rose comprising:
a body comprising a first face;
a rotatable member configured to rotate about a first axis, the rotatable member comprising an outer perimeter;
a spindle receiving aperture extending along the first axis, wherein the spindle receiving aperture extends through the body and the rotatable member; and
a resilient member coiled about the first axis, the resilient member comprising a fixed end and a free end, wherein the fixed end is fixed to the body and the free end is coupled to the rotatable member,
wherein the body comprises a recess defined by an inner perimeter, the recess configured to house the resilient member and the rotatable member, and
wherein the resilient member biases the rotatable member to a first position and in the first position the angle between the free end and the fixed end relative to the centre of the coiled resilient member is at least 90 degrees.
